(19) United States
(12) Patent Application Publication
(10) Pub. No.: US 2022/0094035 A1
(43) Pub. Date: Mar. 24, 2022

(54) ANTENNA HAVING COMPLEMENTARY MONOPOLE AND SLOT

(71) Applicant: Hewlett-Packard Development Company, L.P., Spring, TX (US)

(72) Inventors: Chien-Pai Lai, Taipei City (TW); Shih Huang Wu, Spring, TX (US); Po Chao Chen, Taipei City (TW)

(73) Assignee: Hewlett-Packard Development Company, L.P., Spring, TX (US)

(21) Appl. No.: 17/296,721

(22) PCT Filed: Jun. 11, 2019
(86) PCT No.: PCT/US2019/036546

§ 371 Date: May 25, 2021

(51) Int. Cl. H01Q 1/22; H01Q 9/42; H01Q 1/24

(52) U.S. Cl. CPC H01Q 1/2266; H01Q 1/243; H01Q 9/42

(57) ABSTRACT

An antenna includes a conductive monopole and a non-conductive slot. The non-conductive slot of the antenna has a shape complementary to a shape of the conductive monopole of the antenna. The conductive monopole of the antenna and the non-conductive slot of the antenna are 180-degree rotationally symmetric to one another about a center of the antenna.

### BACKGROUND

Computing devices, including computers such as desktop, laptop, notebook, and convertible computers, as well as computing devices like smartphones, tablet computing devices and other types of computing devices, commonly include wireless communication capabilities. Such wireless communication capabilities can permit computing devices to communicate using Wi-Fi and Bluetooth communication protocols, as well as over mobile networks, which are also referred to as cellular networks. Current mobile networks use fourth generation (4G) Long-Term Evolution (LTE) communication protocols, and to a lesser extent slower third generation (3G) and even second generation (2G) protocols. However, infrastructure is already being deployed to take advantage of next generation fifth generation (5G) protocols, which offer even faster speeds than 4G LTE protocols, and indeed the early groundwork for sixth generation (6G) protocols is already being laid.

### BRIEF DESCRIPTION OF THE DRAWINGS

FIGS. 1A and 1B are diagrams depicting a first example of an antenna.

FIGS. 2A and 2B are diagrams depicting a second example of an antenna.

FIGS. 3A and 3B are diagrams depicting a third example of an antenna.

FIGS. 4A and 4B are diagrams depicting a fourth example of an antenna.

FIGS. 5 and 6 are diagrams of example computing devices in which the example antennas can be disposed.

FIG. 7 is a plot of the frequency response for the example antenna of FIGS. 1A and 1B.

FIG. 8 is a block diagram of an example antenna.

FIG. 9 is a block diagram of an example computing device including an antenna.

### DETAILED DESCRIPTION

As noted in the background, computing devices commonly include wireless communication capabilities. To be able to wirelessly communicate, a computing device includes one or more antennas to transmit and receive data. For example, a computing device may have a pair of antennas to communicate over a mobile or cellular network. One or both of the antennas may be a transceiving antenna that can be used for both data transmission and data reception, or there may be one antenna for data transmission purposes and another antenna for data reception purposes.

Wireless data communication can occur on different frequencies for different communication protocols, such as 4G LTE versus 3G. Furthermore, different countries or regions may use different frequencies for the same communication protocol, and different network providers within the same country or region may even use different frequencies for the same protocol. Computing device manufacturers either have to include different antennas depending on where the computing devices are intended to be used and/or with which network providers the devices are intended to be used, or use antennas that can communicate over a wide band of different frequencies.

The coming adoption of the 5G communication protocol has further complicated this issue. The widespread switchover from 4G LTE to 5G will take time, and for a number of years both communication protocols will be in active use. For instance, urban areas may see widespread adoption of 5G before more rural, less population areas do. Therefore, computing device manufacturers have to either include additional 5G frequency antennas, or use antennas that can communicate over both 4G LTE and 5G frequencies.

Furthermore, available space for antennas within all types of computing devices space is at an increasing premium; weight constraints are also an issue. Devices like smartphones have become increasingly thinner, as have laptop and notebook computers, and manufacturers have tried to make succeeding generations of devices lighter in weight, or reserve more space and weight for batteries at the expense of other components like antennas. At the same time, manufacturers have attempted to increase screen size without increasing overall device size, or to maintain screen size while minimizing overall device size, by decreasing visible bezels around the screens and thus increasing what is referred to as screen-to-body (STB) ratio.

One type of antenna that can provide for a wide brand of frequencies and therefore accommodate both 5G and 4G LTE frequencies within a single antenna is known as a self-complementary antenna (SCA). An SCA is an arbitrarily shaped antenna that includes half of an infinitely extended planar-sheet conductor such that the shape of its complementary structure is exactly identical, or self-complementary, with that of the original structure. However, SCAs that are compact suffer from undue complexity, making their inclusion in computing devices cost prohibitive in many instances. Less complex SCAs, by comparison, require relatively large conductive planes and antenna clearances, thus necessitating larger amounts of space within computing devices.

Described herein are example antennas that provide for a wide band of frequencies, including both 5G and 4G LTE frequencies, while ameliorating the issues that SCAs have. Such an antenna can include a conductive monopole and a non-conductive slot adjacent to the conductive monopole. The monopole and the slot have shapes that are complementary to one another. The monopole and the slot can have 180-degree rotational symmetry to one another about the center of the antenna.

Computing devices manufacturer can thus include a single antenna for communication over both 5G and 4G LTE frequencies within their devices. There may be one instance of the antenna for data transmission and another instance for data reception. In the context of a laptop or notebook computer, the antennas can be located to either side of a trackpad or other pointing device, instead of within the bezel above the screen, to maximize STB ratio. The antennas may be located on the backside of the display of a computing device, including a laptop or notebook computer, or other computing device like a smartphone, tablet computing device, and so on, to maximize STB ratio as well.

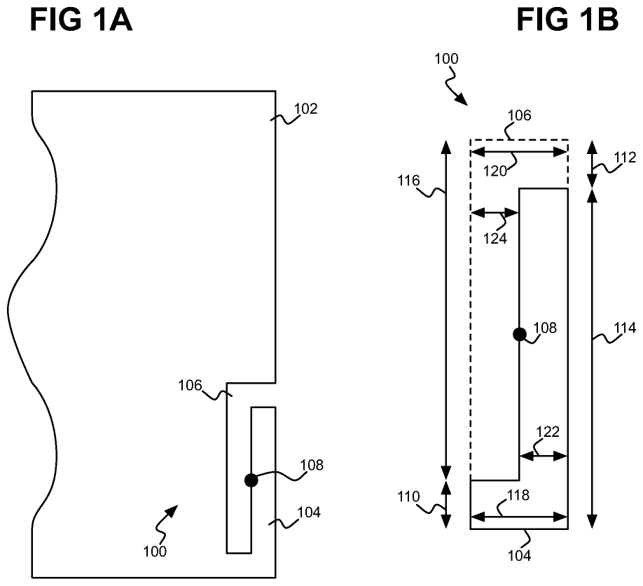

FIGS. 1A and 1B show an example antenna 100. FIG. 1A depicts the antenna 100 with respect to its location at a corner of a conductive chassis 102, which may be the chassis of a computing device of which the antenna 100 is a part. FIG. 1B depicts the antenna 100 by itself in more detail. The conductive chassis 102 is made from a conductive material, such as metal.

The antenna 100 includes a conductive monopole 104 and a non-conductive slot 106 adjacent to the monopole 104. The monopole 104 can be conductive in that it is part of the conductive material of the chassis 102. The slot 106 can be non-conductive in that it is made from a different, non-conductive material such as a plastic resin or other non-metal or non-metallic material, or as specifically depicted in the example of FIG. 1A, corresponds to an aperture or void within the conductive material of the chassis 102. As such, the conductive material of the chassis 102 is in one implementation patterned to form the monopole 104 and the slot 106, with the slot 106 being a void and thus an air or other ambient gas aperture or dielectric material.

The monopole 104 and the slot 106 have shapes that are complementary to one another. This means that the shape of the monopole 104 corresponds to and fits into the shape of the slot 106, and vice-versa. As such, each edge of the monopole 104 facing an edge of the slot 106 is in contact with that edge, since the monopole 104 and the slot 106 are adjacent to one another. In the example antenna 100, the monopole 104 is made up of one contiguous L-shaped monopole region and the slot 106 is similarly made up of one contiguous L-shaped slot region.

The complementarity of the monopole 104 and the slot 106 extends to their corresponding edges as well. The width 110 of the short leg of the monopole 104 is equal to the width 112 of the short leg of the slot 106. The length 114 of the long leg of the monopole 104 is equal to the length 116 of the long leg of the slot 106. The length 118 of the short leg of the monopole 104 is equal to the length 120 of the short leg of the slot 106. The width 122 of the long leg of the monopole 104 is equal to the width 124 of the long leg of the slot 104.

The monopole 104 and the slot 106 have 180-degree rotational symmetry to one another about the center 108 of the antenna 100. 180-degree rotational symmetry means that shape is maintained after 180-degree rotation. That is, rotating the antenna 100 by 180 degrees about the center 108 results in the position and orientation of the shape of the monopole 104 corresponding to the position and orientation of the shape of the slot 106 prior to rotation, and in the position and orientation of the shape of the slot 106 corresponding to the position and orientation of the shape of the slot 106 prior to rotation.

For instance, the monopole 104 and the slot 106 are each L-shaped in the example antenna 100. The long leg of the monopole 104 extends upwards from its outside lower-right corner, and the short leg extends leftwards from the outside lower-right corner. The long leg of the slot 106 extends downwards from its outside upper-left corner, and the short leg extends rightwards from the outside upper-right corner. Rotating the antenna 100 thus would result in the long leg and the short leg of the monopole 104 respectively extending downwards and rightwards from the outside upper-left corner and the long leg and the short leg of the slot 106 respectively extending upwards and leftwards from the outside lower-right corner, since the monopole 104 and the slot 106 have 180-degree rotational symmetry.

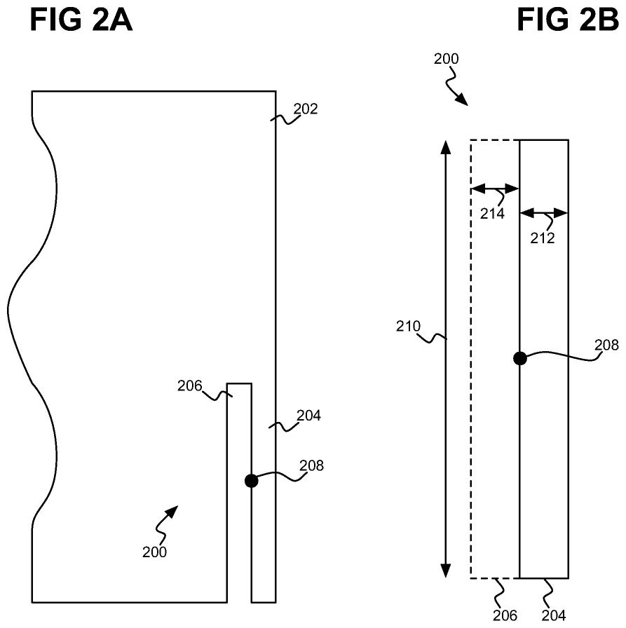

FIGS. 2A and 2B show another example antenna 200. FIG. 2A depicts the antenna with respect to its location at a corner of a conductive chassis 202, which like the chassis 102 of FIG. 1A may be the chassis of a computing device in which the antenna 200 is a part. FIG. 2B depicts the antenna 200 by itself in more detail. The conductive chassis 202, like the chassis 102, is made from a conductive material, such as metal.

The antenna 200 includes a conductive monopole 204 and a non-conductive slot 206 adjacent to the monopole 204. The monopole 204, like the monopole 104 of FIGS. 1A and 1B, can be conductive in that it is part of the conductive material of the chassis 202. The slot 206, like the slot 106 of FIGS. 1A and 1B, can be non-conductive in that it is made from a different, non-conductive material, such as a plastic resin or other non-metal or non-metallic material, or as specifically depicted in the example of FIG. 2A, corresponds to an aperture or void within the conductive material of the chassis 202. As such, the conductive material of the chassis 202 is in one implementation patterned to form the monopole 204 and the slot 206, with the slot 206 being a void and thus an air or other ambient gas aperture or dielectric material.

As in FIGS. 1A and 1B, the monopole 204 and the slot 206 have shapes that are complementary to one another. In the example antenna 200, the monopole 204 is made up of one contiguous rectangularly shaped region. The slot 206 is likewise made up of one contiguous rectangularly shaped region. As in FIGS. 1A and 1B, the complementarity of the monopole 204 and the slot 206 extends to their corresponding edges. The monopole 204 and the slot 206 have the same length 210. The width 212 of the monopole 204 is equal to the width 214 of the slot 206. As in FIGS. 1A and 1B, the monopole 204 and the slot 206 have 180-degree rotational symmetry to one another about the center 208 of the antenna 200.

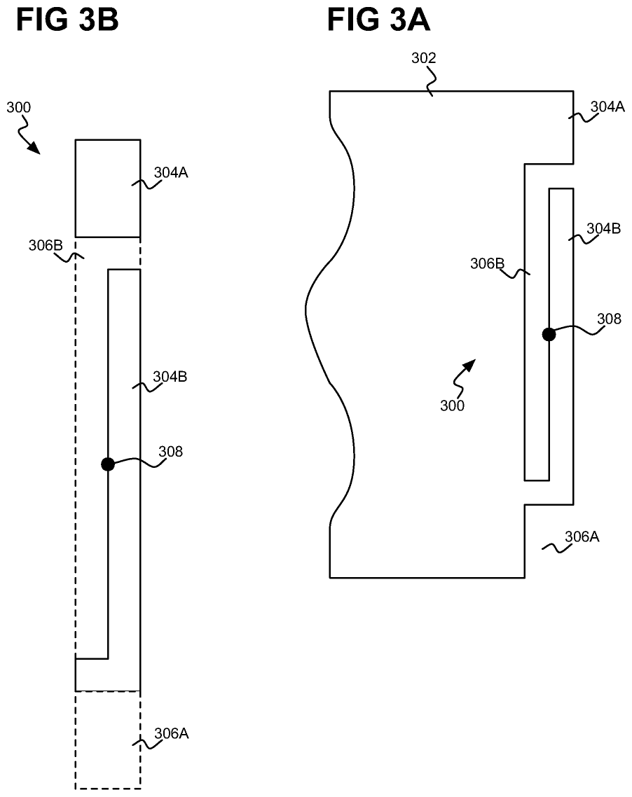

FIGS. 3A and 3B show another example antenna 300. FIG. 3A depicts the antenna with respect to its location at an edge of a conductive chassis 302, and thus with respect to two corners of the chassis 302, which like the chassis 102 of FIG. 1A may be the chassis of a computing device of which the antenna 300 is a part. FIG. 3B depicts the antenna 300 by itself in more detail. The conductive chassis 302, like the chassis 102, is made from a conductive material, such as metal.

The antenna 300 includes a conductive monopole and a non-conductive slot. Specifically, the antenna 300 includes two noncontiguous conductive monopole regions 304A and 304B, which together are said to form the conductive monopole. The monopole region 304A is L-shaped and the monopole region 304B is rectangularly shaped. The monopole regions 304A and 304B are noncontiguous in that, per FIG. 3B, within the antenna 300 itself the region 304A is not contiguous to the region 304B, even though the regions 304A and 304B are contiguous to one another in consideration of the chassis 302 as a whole of which the antenna 300 is a part, per FIG. 3A.

The antenna 300 includes two noncontiguous non-conductive slot regions 306A and 306B, which together are said to form the non-conductive slot. The slot region 306A is L-shaped and the slot region 306B is rectangularly shaped. The slot regions 306A and 306B are similarly noncontiguous in that, per FIG. 3B, within the antenna 300 itself the region 306A is not contiguous to the region 306B. This is the case even though the regions 306A and 306B are contiguous to one another in consideration of the chassis 302 as a whole of which the antenna 300 is a part, per FIG. 3A.

The monopole of the antenna 300, like the monopole 104 of FIGS. 1A and 1B, can be conductive in that it is part of the conductive material of the chassis 302. The slot of the antenna 300, like the slot 106 of FIGS. 1A and 1B, can be non-conductive in that it is made from a different non-conductive material such as a plastic resin or other non-metal or non-metallic material, or as specifically depicted in the example of FIG. 3A, correspond to an aperture or void of multiple aperture or void regions (that correspond to the slot regions 306A and 306B) within the conductive material of the chassis 302. As such, the conductive material of the chassis 302 is in one implementation patterned to form the monopole and the slot of the antenna 100, with the slot (i.e., the slot regions 306A and 306B) being a void and thus an air or other ambient gas aperture or dielectric material.

As in FIGS. 1A and 1B, the monopole and the slot of the antenna 300 have shapes that are complementary to one another. Specifically, the shapes of the monopole region 304A and the corresponding slot region 306A are complementary to one another, and likewise the shapes of the monopole region 304B and the corresponding slot region 306B are complementary to one another. As in FIGS. 1A and 1B, the complementarity of the monopole and the slot of the antenna 300 extends to their corresponding edges, with the lengths and widths of corresponding monopole and slot regions being equal to one another. As in FIGS. 1A and 1B, the monopole and the slot of the antenna 300 have 180-degree rotational symmetry to one another about the center 308 of the antenna 300.

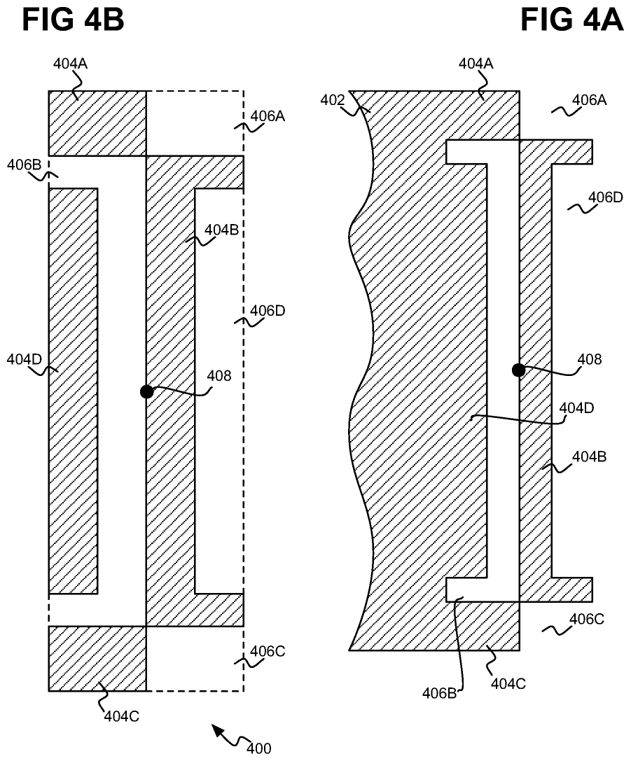

FIGS. 4A and 4B show another example antenna 400. FIG. 4A depicts the antenna with respect to its location at an edge of a conductive chassis 402, and thus with respect to two corners of the chassis 402, which like the chassis 102 of FIG. 1 may be the chassis of a computing device of which the antenna 400 is a part. FIG. 4B depicts the antenna 400 by itself in more detail. The conductive chassis 402, like the chassis 102, is made from a conductive material, such as metal.

The antenna 400 includes a conductive monopole and a non-conductive slot. Specifically, similar to the antenna 300 of FIGS. 3A and 3B, the antenna 400 includes multiple (in particular, four) noncontiguous monopole regions 404A, 404B, 404C, and 404D, which together form the conductive monopole. The monopole regions 404A, 404C, and 404D are rectangularly shaped, and the monopole region 404B is C-shaped. The regions 404A and 404C in the example of FIGS. 4A and 4B are identical in size and dimension.

Also similar to the antenna 300 of FIGS. 3A and 3B, the antenna 400 includes multiple (in particular, four) noncontiguous slot regions 406A, 406B, 406C, and 406D, which together form the non-conductive slot. The slot regions 406A, 406C, and 406D are rectangularly shaped, and the monopole region 406B is C-shaped. The regions 406A and 406C in the example of FIGS. 4A and 4B are identical in size and dimension.

The monopole of the antenna 300, like the monopole 104 of FIGS. 1A and 1B, can be conductive in that it is part of the conductive material of the chassis 402. The slot of the antenna 400, like the slot 106 of FIGS. 1A and 1B, can be non-conductive in that it is made from a different non-conductive material such as a plastic resin or other non-metal or non-metallic material, or as specifically depicted in the example of FIG. 4A, correspond to an aperture or void of multiple aperture or void regions (that correspond to the slot regions 406A, 406B, 406C, and 406D) within the conductive material of the chassis 402. As such, the conductive material of the chassis 402 is in one implementation patterned to form the monopole and the slot of the antenna 400, with the slot (i.e., the slot regions 406A, 406B, 406C, and 406D) being a void and thus an air or other ambient gas aperture or dielectric material.

As in FIGS. 1A and 1B, the monopole and the slot of the antenna 400 have shapes that are complementary to one another. Specifically, the shapes of the monopole region 404A and the slot region 406A are complementary to one another; the shapes of the regions 404B and 406B are complementary to one another; the shapes of the regions 404C and 406C are complementary to one another; and the shapes of the regions 404D and 406D are complementary to one another. As in FIGS. 1A and 1B, the complementarity of the monopole and the slot of the antenna 400 extends to their corresponding edges, with the lengths and widths of corresponding monopole and slot regions being equal to one another. As in FIGS. 1A and 1B, the monopole and the slot of the antenna 400 have 180-degree rotational symmetry to one another about the center 408 of the antenna 400.

Four different example antennas having complementary monopoles and slots that are 180-degree rotational symmetric to one another have been described. The antenna 100 of FIGS. 1A and 1B and the antenna 200 of FIGS. 2A and 2B have monopoles and slots that are made up of single contiguous monopole and slot regions. The antenna 300 of FIGS. 3A and 3B and the antenna 400 of FIGS. 4A and 4B have monopoles and slots that are made up of multiple noncontiguous monopole and slot regions. Antennas according to the techniques described herein may also differ from and combine the example antennas that have been presented, so long as their monopoles and slots are complementary and/are 180-degree rotationally symmetric to one another.

The example antennas that have been described can be used in a variety of different computing devices, including desktop computers as well as more portable computers such as laptop, notebook, and convertible computers. Other types of computing devices that can employ the example antennas include smartphones, tablet computing devices, and so on. A computing device may include one or more instances of an antenna. For example, there may be one antenna for data transmission, and another antenna for data reception, or each antenna may be a transceiving antenna that can be used for both data transmission and data reception

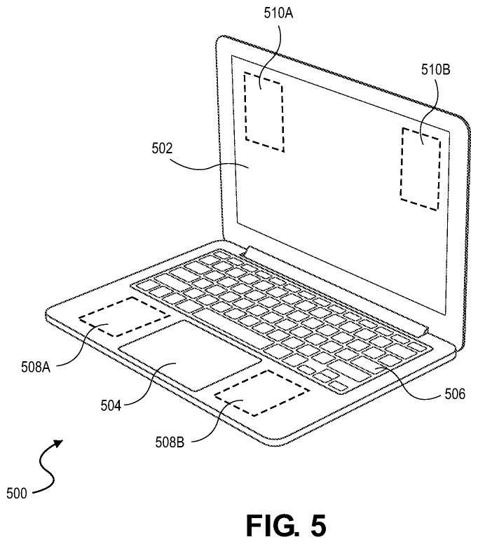

FIGS. 5 and 6 show example computing devices 500 and 600 in which the described example antennas can be used. In FIG. 5, the computing device 500 is a laptop or notebook computer having a display device 502, a trackpad 504, and a keyboard 506. The trackpad 504 is a type of pointing device, and the computing device 500 can include a different type of pointing device (or no pointing device). The trackpad and the keyboard 506 are both types of input devices.

In one implementation, an antenna can be disposed to either or both sides of the trackpad 504, in antenna regions 508A and 508B below the keyboard 506, as part of the chassis of the computing device 500 and within the housing of the device 500. In another implementation, an antenna can be disposed on the backside of the display device 502, in either or each antenna region 510A and 510B, as part of the chassis of the computing device 500 and within the housing of the device 500. In both such implementations, STB ratio may be able to be increased as compared to an implementation in which one or more antennas are disposed within the bezel above the screen, since the bezel may then be thinner.

In FIG. 6, the computing device 600 is a smartphone, but a tablet computing device or other similar computing device may have the same form factor as a rectangular “slab.” The computing device 600 includes a display device 602. Similar to one implementation of FIG. 5, an antenna may be disposed on the backside of the display device 602, in either or each antenna region 604A and 604B, as part of the chassis of the computing device 500 and within the housing of the device 600. STB ratio may again be able to be increased compared to an implementation in which one or more antennas are disposed within the bezel above the screen.

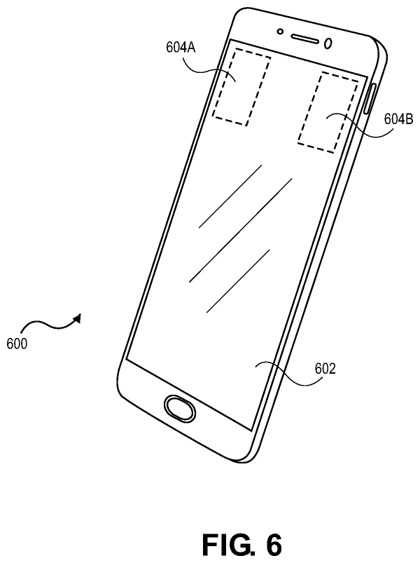

FIG. 7 shows a plot 700 of the frequency response for an example antenna having a monopole and a slot that are complementary to one another, specifically the antenna 100 of FIGS. 1A and 1B. The y-axis 704 of the plot denotes antenna gain in decibels-isotropic (dBi) over the frequencies denoted by the x-axis 702. The solid line 708 indicates the frequency response for an existing antenna that does not have a monopole and a slot that are complementary to one another.

The dashed line 710 indicates the frequency response for the example antenna 100 of FIGS. 1A and 1B. As depicted in FIG. 7, the gain of the example antenna 100 is better for nearly all frequencies as compared to the gain of the existing antenna. The example antenna 100 has particularly good gain as compared to the existing antenna between 3,300 and 5,000 megahertz (MHz), which are prime 5G frequencies in some areas.

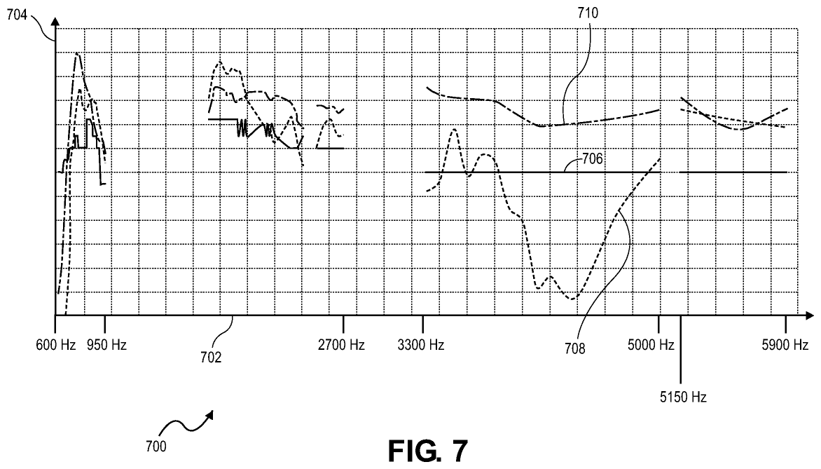

FIG. 8 shows a block diagram of an example antenna 800. The antenna 800 includes a conductive monopole 804 and a non-conductive slot 806. The slot 806 is disposed adjacent to the monopole 804, and the shape of the slot 806 is complementary to the shape of the monopole 804.

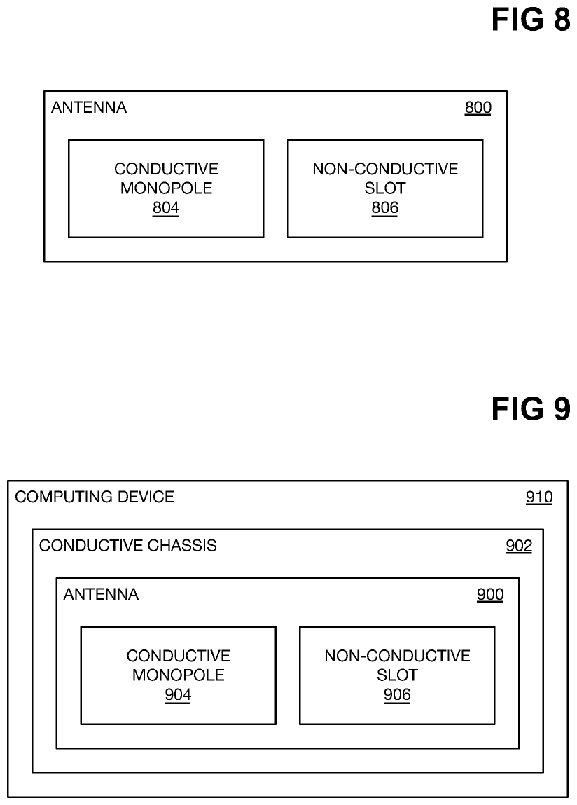

FIG. 9 shows a block diagram of an example computing device 910. The computing device 910 includes a conductive chassis 902 and an antenna 900 that is formed within the chassis 902. The antenna 900 has a conductive monopole 904 and a non-conductive slot 906 that are 180-degree rotationally symmetric to one another about a center of the antenna.

Example antennas have been described herein that can have a wide frequency response, particularly across a frequency range spanning both 4G LTE and 5G frequencies. The antennas have complementary monopoles and slots that have 180-degree rotational symmetry to one another about the centers of the antennas. Unlike SCAs, the example antennas herein can require less space, and can have less complexity, resulting in lower manufacturing cost.

We claim:

1. An antenna comprising:
a conductive monopole having a shape; and
a non-conductive slot adjacent to the conductive monopole and having a shape complementary to the shape of the conductive monopole.

2. The antenna of claim 1, wherein the conductive monopole and the non-conductive slot have 180-degree rotational symmetry to one another about a center of the antenna.

3. The antenna of claim 1, further comprising:
a conductive material including the conductive monopole; and
an aperture within the conductive material and corresponding to the non-conductive slot.

4. The antenna of claim 1, further comprising:
a conductive material patterned to form the conductive monopole and the non-conductive slot within the conductive material.

5. The antenna of claim 1, wherein the conductive monopole comprises a single contiguous monopole region and the non-conductive slot comprises a single contiguous slot region complementary to the single contiguous monopole region.

6. The antenna of claim 5, wherein the single contiguous monopole region and the single contiguous slot region are each L-shaped.

7. The antenna of claim 5, wherein the single contiguous monopole region and the single contiguous slot region are each rectangularly shaped.

8. The antenna of claim 1, wherein the conductive monopole comprises a plurality of noncontiguous monopole regions and the non-conductive slot comprises a plurality of noncontiguous slot regions complementary to the noncontiguous monopole regions.

9. The antenna of claim 8, wherein the noncontiguous monopole regions comprise an L-shaped monopole region and a rectangularly shaped monopole region,
and wherein the noncontiguous slot regions comprise an L-shaped slot region complementary to the L-shaped monopole region and a rectangularly shaped slot region complementary to the rectangularly shaped monopole region.

10. The antenna of claim 8, wherein the noncontiguous monopole regions comprise a C-shaped monopole region and a rectangularly shaped monopole region,
and wherein the noncontiguous slot regions comprise a C-shaped slot region complementary to the C-shaped monopole region and a rectangularly shaped slot region complementary to the rectangularly shaped monopole region.

11. A computing device comprising:
a conductive chassis; and
an antenna formed within the conductive chassis and having a conductive monopole and a non-conductive slot that are 180-degree rotationally symmetric to one another about a center of the antenna.

12. The computing device of claim 11, wherein the non-conductive slot has a shape complementary to a shape of the conductive monopole.

13. The computing device of claim 11, wherein the conductive chassis has an antenna region at a corner of the conductive chassis that is patterned to form the conductive monopole and the non-conductive slot within the conductive chassis.

14. The computing device of claim 11, further comprising:
an input device,
wherein the antenna is disposed to one side of the input device.

15. The computing device of claim 11, further comprising:
a display device,
wherein the antenna is disposed on a backside of the display device.
